(19) United States
(12) Patent Application Publication
(10) Pub. No.: US 2015/0055471 A1
(43) Pub. Date: Feb. 26, 2015

(54) SYSTEM AND METHOD FOR QUALITY-BASED OPTIMIZATION OF NETWORK TRAFFIC

(71) Applicant: Rajant Corporation, Malvern, PA (US)

(72) Inventors: Paul R. HELLHAKE, Downingtown, PA (US); David Acker, Malvern, PA (US); Joseph E. Parks, Coatesville, PA (US); William Jordan, Ephrata, PA (US)

(73) Assignee: Rajant Corporation, Malvern, PA (US)

(21) Appl. No.: 14/076,645

(22) Filed: Nov. 11, 2013

Related U.S. Application Data
(60) Provisional application No. 61/868,300, filed on Aug. 21, 2013.

(51) Int. Cl. H04L 12/833; H04L 12/859

(52) U.S. Cl. CPC H04L 47/2458; H04L 47/2475
USPC 370/235

(57) ABSTRACT

The protocol determines the quality of each node to node link(s), based on an exponentially weighted moving average of the time each packet spends within the network node. Once determined, that quality of link is then mapped into the physical QoS resources of the networking hardware in use (within the network). Packets destined for higher quality links will see an upgrade of their QoS rating, while packets destined to lower quality links will see a downgrade of their QoS rating. That adjustment permits the higher quality links to be processed before the lower quality links resulting in more efficient and complete communications in the network. Poorer quality links will no longer act as roadblocks to the higher quality packets.

### REFERENCE TO RELATED APPLICATION

The present application is a non-provisional of U.S. Provisional Application Ser. No. 61/868,300, filed Aug. 21, 2013, whose disclosure is hereby incorporated by reference in its entirety into the present disclosure.

### FIELD OF THE INVENTION

The present invention is directed to a system and method for implementing a network protocol wherein multiple nodes communicate in a static or dynamic environment, communicating with each other to optimize communications, by prioritizing and processing messages based upon the quality of data transmitted, the quality of connections, and the quality of links between peers.

### DESCRIPTION OF RELATED ART

In transmission of packets through a network, queuing delays sometimes occur, dependent upon volume of traffic and to the quality of the connection. Further complicating the traditional processes are inferior quality connections resulting from multiple packet delivery retries and eventual potential delivery or failure, all inherent in a dynamic mesh environment and in a static network with multiple client nodes.

In simple networks, there may be mostly links between nodes that are not affected by each other's traffic. However, in more complex networks, including but not limited to radio and mesh networks, data packets will be compromised due to the nature of the network and its constituent hardware. The compromised data packets will cause the hardware to execute multiple retries to deliver the data, resulting in increased traffic and congestion in the network.

In the prior art, there are networks that prioritize packets based on some standardized Quality of Service (QoS) metrics. That establishes a priority among packets, allowing high priority packets to pass low priority packets at a node. However, existing QoS protocols are largely based on fixed quality requirements, such as audio/video media types and foreground and background data types. That type of QoS allows high priority packets to pass low priority packets but does not address the situation when multiple traffic streams of equal QoS priority need to go to different clients or mesh peers of different link quality. Poor quality links may not only run slower, but also likely result in multiple retries, causing one packet to act as a roadblock to many others, at least some of which would clear immediately if not for the poor quality links.

### SUMMARY OF THE INVENTION

The present invention addresses the circumstance in a network where multiple nodes attempt to communicate by transmitting data packets to neighboring nodes and throughout the network. The present invention implements a protocol that prioritizes data packet delivery based upon the quality of connections between the nodes and the network, permitting good quality communications to be processed before poorer quality communications, creating dramatically improved network efficiencies by reallocating limited network resources and improving the quality of communication across the network. “Quality” is a metric comprised of reliability and latency.

The protocol determines the quality of each node to node link(s), based on an exponentially weighted moving average of the time each packet spends within the network node. Once determined, this quality of link is then mapped into the physical QoS resources of the networking hardware in use (within the network). Packets destined for higher quality links will see an upgrade of their QoS rating, while packets destined to lower quality links will see a downgrade of their QoS rating. This adjustment permits the higher quality links to be processed before the lower quality links resulting in more efficient and complete communications in the network. Poorer quality links will no longer act as roadblocks to the higher quality packets.

The present invention includes systems, devices, and methods to improve aggregate network performance in any network using limited common hardware resources with variable transmission rate(s) and is also particularly applicable to dynamic meshing networks, such as self-healing mobile mesh networks, by means of packet prioritization driven by specific monitored performance metrics and statistics.

### BRIEF DESCRIPTION OF THE DRAWINGS

The objects, features, and advantages of the present invention will be apparent to those skilled in the art in light of the following detailed description of the invention in which:

FIG. 1 is a flow chart showing a process according to a preferred embodiment of the present invention; and

FIG. 2 is a block diagram showing hardware on which the preferred embodiment can be implemented.

### DETAILED DESCRIPTION OF THE PREFERRED EMBODIMENT

A preferred embodiment of the invention will be set forth in detail with reference to the drawings.

In general terms, the preferred embodiment, called Passing Lanes Protocol, is designed to set or modify Quality of Service (QoS) parameters in a network, based on a metric that determines the quality of the link to a packet's destination. The invention ideally works with multiple hardware queues in each network interface device, in order to optimize each packet's priority, based on both original packet priorities and link quality. In the ideal situation, the source device would have a dedicated transmit queue at the hardware and software layer for each peer.

The 802.11 protocol is one example of a protocol with which the preferred embodiment can be used. 802.11 wireless access points must be able to communicate with wireless clients that are in various locations and can be subject to various inefficiencies in diverse circumstances. The varied locations and diverse circumstances can have a substantial effect on how well the radio frequencies travel from the source access point to the destination client. Similarly, wireless devices in an ad hoc mesh must communicate to peers in various conditions and in ever-changing locations and environments.

In actual hardware implementations, there is only one physical radio with perhaps four hardware queues per device to device link. In typical 802.11 devices, the queues are used to implement priorities by way of QoS using Wireless Multimedia Extensions (WME). Data is generally prioritized by importance as first voice, then video, followed by best effort and background data. That permits the typically more latency sensitive packets of data to be processed before the less time sensitive data packets. Often packet header fields like VLAN Priority (802.1Q Tag Control Information Priority Code Point) in Ethernet frames or Type of Service (TOS) or Differentiated Services Code Point (DSCP) in Internet Protocol Version Four (IPv4) and Internet Protocol Version Six (IPv6) packet headers) are used to select the appropriate QoS WME hardware queue. Software maps the packet field's priority to one of the four hardware queues.

This type of QoS priority allows high priority packets to pass low priority packets but does not address the situation when multiple traffic streams of equal QoS priority need to go to different wireless clients or mesh peers. Generally speaking, lower wireless bit-rates can reach farther and are more easily demodulated. Also, many wireless devices must drop their transmit power at higher bit-rates to avoid increasing the transmit bit-error-rate. In a dynamic mobile mesh network, as clients or mesh peers move into locations that are difficult to reach, the sender must decrease the wireless bit-rate to increase the chance of the signal reaching the peer and being received properly. It also must allow multiple retries, with some occurring at bit-rates lower than the initial attempt. Packets destined for wireless clients or mesh peers that have high quality connections to have to wait behind the slower lesser quality packets destined for the wireless clients or mesh peers with poor quality connections. The result is a barrier to the higher quality packets being delayed behind the lower quality packets creating a traffic jam of data with all the data moving throughout the network at the speed of the slowest packet. This is analogized to the slowest vehicle on a single lane highway blocking all traffic behind it. In Passing Lanes protocol, packets are assigned to express lanes similar to HOV lanes on a highway, resulting in a temporarily dedicated high speed and quality lane which allows the higher quality and faster packets to pass the slower lower quality packets and reach their destinations in a more orderly and efficient manner.

If the packets are placed into hardware queues based on the relative quality of the links to their destination, packets to high quality links no longer have to wait for packets destined to low quality links. Passing Lanes uses the quality of the link to determine the appropriate hardware queue to use. That allows high quality packets to pass lower quality packets at the radio.

In one embodiment, the quality of the link is determined by the exponentially weighted moving average (EWMA) of the time each packet spends within the node. That is the total time from when the packet is initially received to when it has been acknowledged by the next location in the network. EWMA uses a coefficient to weight the historical average and the latest sample. By varying the coefficient, more emphasis can be given to historical data or more recent data.

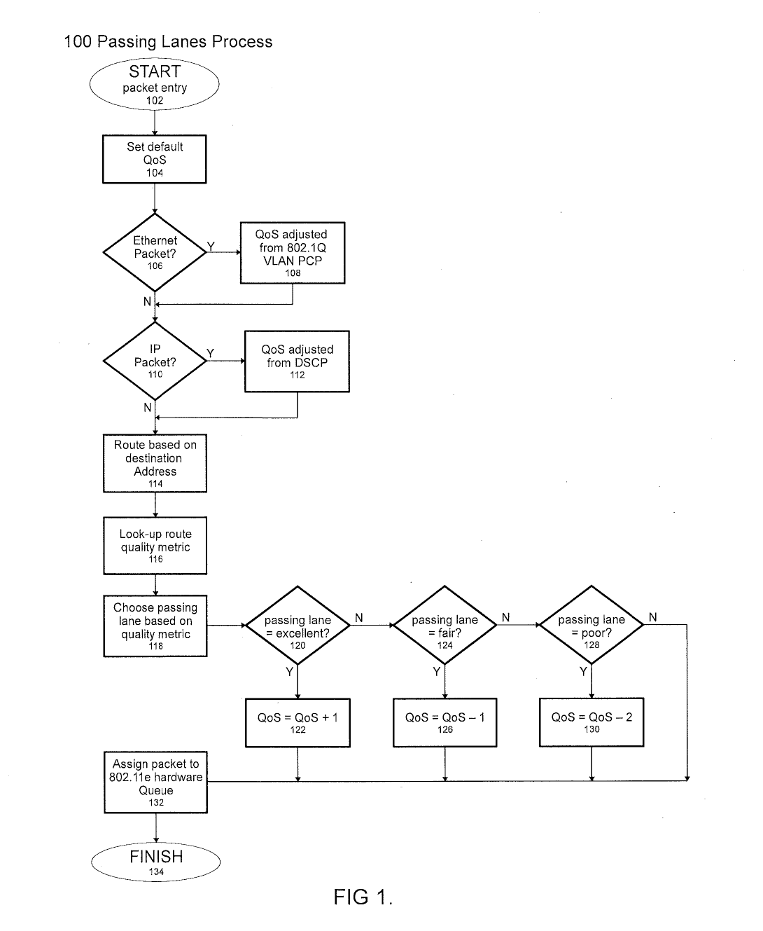

Once the quality metrics have been determined, the links are broken into different quality groups with each quality group adjusting the current hardware WME QoS queue assignment. The WME QoS queues are designated in order of increasing priority: background, best effort, video, and voice. This is illustrated in FIG. 1.

At packet entry 102, a default QoS value is set 104 for each packet. In the case of an Ethernet packet 106, that QoS value is adjusted based on the 802.1Q VLAN priority code point (PCP) tags 108. If the packet is an Internet Protocol (IP) packet, the working QoS value is adjusted from differentiated services code point (DSCP) priorities 112. Once adjusted, the packet is routed to the proper hardware interface based on its destination address in the network/mesh 114.

At the interface, the link quality determination 116 is local to that specific network interface. That quality number is indexed against a translation table to implement the Passing Lanes adjustment 118. The QoS value is then grouped against the specific rules for the interface in question.

Links that have an excellent quality metric 120 get their QoS priority increased by one 122. Links that have good quality have their QoS priority left at the value originally designated. By default, that may be best effort. Links that have fair quality 124 have their QoS priority decreased by one 126. Finally, links that have poor quality 128 have their QoS priority decreased by two 130. The quality metrics must be configurable, as different environments will have different rules for what constitutes excellent quality compared to good quality.

An example of mapping base QoS priorities to queues is shown in Tables I and II below. Their initial queue is always the Best Effort queue. That establishes a baseline for upward or downward departures of queues in the network. Priorities are adjusted up/down from that base. Note that in this configuration, links that are rated fair quality and links that are rated poor quality are put into the same queue. That would not be true if there were prior QoS adjustments. If the stream of packets all had a VLAN priority that put them in the Video queue by default, we would obtain a different mapping.

TABLE I
Adjustment values from base QoS for 802.11 hardware queues

| Passing | Priority | Resulting Hardware |
|---|---|---|
| Lane | Adjustment | Queue |
| Excellent | +1 | Video |
| Good | 0 | Best Effort |
| Fair | −1 | Background |
| Poor | −2 | Background |

TABLE II
Adjustments from prior QoS settings

| Passing Lane | Initial Queue | Priority Adjustment | Resulting Queue |
|---|---|---|---|
| Excellent | Video | +1 | Voice |
| Good | Video | 0 | Video |
| Fair | Video | −1 | Best Effort |
| Poor | Video | −2 | Background |

Tables III and IV illustrate an example where we have eight links with quality metrics of 500, 1,000, 2,000, 4,000, 8,000, 16,000, 32,000, 64,000. Lower values indicate higher quality. The default quality metrics are such that a quality value of no more than 5,000 is required for excellent quality links, a quality value of no more than 10,000 is required for good quality links, a quality value of no more than 20,000 is required for fair quality links, while all other links are considered poor quality links. Poor quality links generally are categorized as slower than other links, and less reliable.

TABLE III
Grading of metrics for 802.11 hardware queues

| Passing Lane | Quality Metric |
|---|---|
| Excellent | <=5,000 |
| Good | >5,000 and <=10,000 |
| Fair | >10,000 and <=20,000 |
| Poor | >20,000 |

TABLE IV
Grading metric examples

| Link Quality | Passing Lane | Hardware Queue |
|---|---|---|
| 500 | Excellent | Video |
| 1,000 | Excellent | Video |
| 2,000 | Excellent | Video |
| 4,000 | Excellent | Video |
| 8,000 | Good | Best Effort |
| 16,000 | Fair | Background |
| 32,000 | Poor | Background |
| 64,000 | Poor | Background |

In the example of Table IV, all of the high quality links run together on the same queue, since none of them will significantly affect any of the others in that queue. The lower quality links get moved to the lower priority queues, allowing rapid delivery of many high quality packets on better quality links while lower quality links are effectively removed from the high speed lane.

Table V illustrates the case of even a single bad link not affecting delivery of the higher quality links. This system prevents one bad link from slowing many good links. In this example, all of the high quality links stay on the second highest priority queue, while the single low quality link goes to the lowest priority queue.

TABLE V
Link quality metrics to hardware queue example

| Link Quality | Passing Lane | Hardware Queue |
|---|---|---|
| 500 | Excellent | Video |
| 1,000 | Excellent | Video |
| 1,500 | Excellent | Video |
| 2,000 | Excellent | Video |
| 2,500 | Excellent | Video |
| 3,000 | Excellent | Video |
| 3,500 | Excellent | Video |
| 15,000 | Fair | Background |

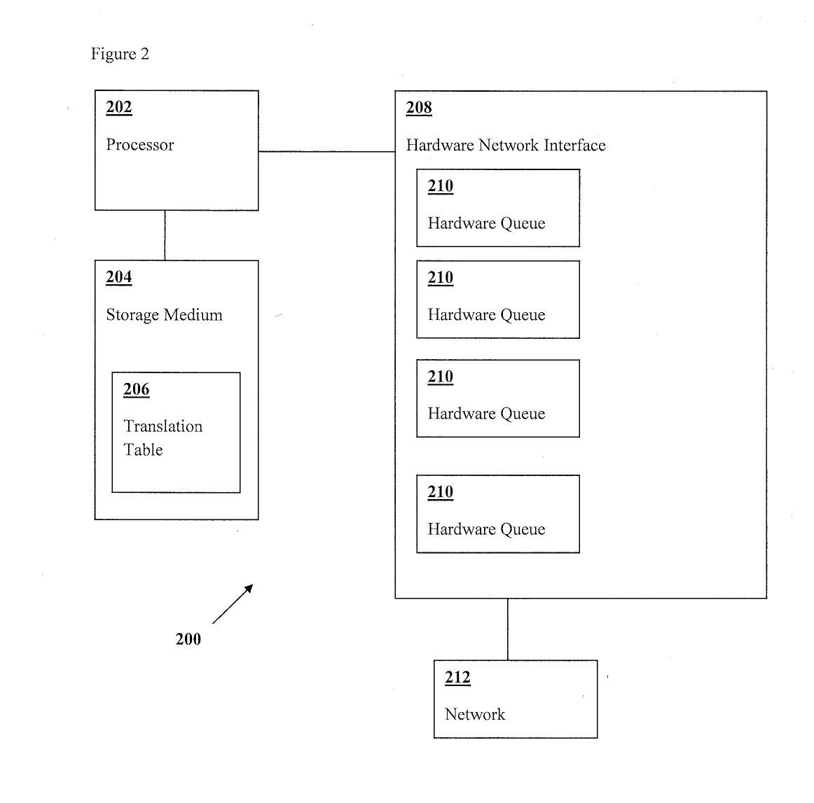

An example of hardware on which the preferred embodiment can be implemented will be set forth in detail with reference to FIG. 2. In the system 200, a processor 202 is connected to a storage medium (e.g., RAM) 204 that stores a translation table 206. The processor 202 is also connected to a hardware network interface 208 that implements four hardware queues 210 and provides communication over the network 212. The hardware network interface 208 can be any suitable wired or wireless hardware network interface. The processor 202 is configured to implement the functionality above.

While a preferred embodiment has been set forth in detail above, those skilled in the art who have reviewed the present disclosure will readily appreciate that other embodiments can be realized within the scope of the invention. For example, recitations of numerical values, categories of data, and network protocols are illustrative rather than limiting. Therefore, the present invention should be construed as limited only by the appended claims.

What is claimed is:

1. A method for quality-based prioritization of packets in a network, the method comprising:
(a) assigning a quality-of-service rating to each of the packets;
(b) determining a destination of each of the packets;
(c) determining a link quality for the destination of each of the packets;
(d) for each of the packets, adjusting the quality-of-service rating in accordance with the link quality to form an adjusted quality-of-service rating;
(e) establishing priorities for the packets in accordance with the adjusted quality-of-service rating of each of the packets; and
(f) supplying the packets to one or more hardware queues in accordance with the priorities for transmission through the network.

2. The method of claim 1, wherein step (a) is performed in accordance with a type of data of each of the packets.

3. The method of claim 2, wherein step (a) is performed in accordance with a time sensitivity of each said type of data.

4. The method of claim 3, wherein the type of data for each of the packets is selected from the group consisting of background, best effort, video, and voice.

5. The method of claim 1, wherein step (c) is performed in accordance with a moving average at a node corresponding to the destination.

6. The method of claim 5, wherein the moving average is an exponentially weighted moving average.

7. The method of claim 1, wherein the network comprises a plurality of hardware network interfaces, and wherein step (c) is performed in accordance with one of the plurality of hardware network interfaces through which each of the packets is to be sent.

8. The method of claim 1, wherein step (d) comprises using a translation table to determine an amount by which the quality-of-service rating is to be adjusted in accordance with the link quality.

9. The method of claim 8, wherein the translation table provides an amount to be added to or subtracted from the quality-of-service, rating.

10. The method of claim 1, wherein step (f) comprises ordering the packets in accordance with the priorities such that those of the packets for which the priorities are higher are transmitted before those of the packets for which the priorities are lower.

11. A system for quality-based prioritization of packets in a network, the system comprising:
one or more hardware network interfaces for transmitting the packets through the network, the one or more hardware network interfaces implementing one or more hardware queues; and
a processor, in communication with the one or more hardware network interfaces, configured for:
(a) assigning a quality-of-service rating to each of the packets;
(b) determining a destination of each of the packets;
(c) determining a link quality for the destination of each of the packets;
(d) for each of the packets, adjusting the quality-of-service rating in accordance with the link quality to form an adjusted quality-of-service rating;
(e) establishing priorities for the packets in accordance with the adjusted quality-of-service rating of each of the packets; and
(f) supplying the packets to the one or more hardware queues in accordance with the priorities for transmission through the network.

12. The system of claim 11, wherein the processor is configured to perform step (a) in accordance with a type of data of each of the packets.

13. The system of claim 12, wherein the processor is configured to perform step (a) in accordance with a time sensitivity of each said type of data.

14. The system of claim 13, wherein the processor is configured such that the type of data for each of the packets is selected from the group consisting of background, best effort, video, and voice.

15. The processor of claim 11, wherein the processor is configured to perform step (c) in accordance with a moving average at a node corresponding to the destination.

16. The system of claim 15, wherein the processor is configured such that the moving average is an exponentially weighted moving average.

17. The system of claim 11, comprising a plurality of said hardware network interfaces, and wherein the processor is configured to perform step (c) in accordance with one of the plurality of hardware network interfaces through which each of the packets is to be sent.

18. The system of claim 11, further comprising a storage medium in communication with the processor, the storage medium storing a translation table, and wherein the processor is configured to perform step (d) by using the translation table to determine an amount by which the quality-of-service rating is to be adjusted in accordance with the link quality.

19. The system of claim 18, wherein the translation table provides an amount to be added to or subtracted from the quality-of-service rating.

20. The system of claim 11, wherein the processor is configured to perform step (f) by ordering the packets in accordance with the priorities such that those of the packets for which the priorities are higher are transmitted before those of the packets for which the priorities are lower.
